(19) United States
(12) Patent Application Publication
(10) Pub. No.: US 2020/0238645 A1
(43) Pub. Date: Jul. 30, 2020

(54) PROCESS FOR MAKING A WHEEL ASSEMBLY FOR A LIGHTWEIGHT VEHICLE

(71) Applicant: Wonderland Switzerland AG, Steinhausen (CH)

(72) Inventor: Chih-Hsun LIN, Taipei (TW)

(21) Appl. No.: 16/393,244

(22) Filed: Apr. 24, 2019

(30) Foreign Application Priority Data
Jan. 30, 2019 (CN) 201910091544.6

(51) Int. Cl. B29D 30/02; B60C 7/10

(52) U.S. Cl. CPC B29D 30/02; B60C 7/105

(57) ABSTRACT

A process for making a wheel assembly for a lightweight vehicle includes the steps of: (a) providing a wheel which includes a rim having a recessed outer surface, (b) disposing a foam tire core on the wheel such that an inner annular surface of the foam tire core is in abutment with the recessed outer surface of the rim, (c) applying an adhesive agent on at least one of an inner surface of a rubber casing and an outer annular surface of the foam tire core, and (d) wrapping the rubber casing on the foam tire core such that the inner surface of the rubber casing is brought into press engagement with the outer annular surface of the foam tire core.

### CROSS-REFERENCE TO RELATED APPLICATION

This application claims priority of Chinese Invention Patent Application No. 201910091544.6, filed on Jan. 30, 2019.

### FIELD

This disclosure relates to a process for making a wheel assembly, and more particularly to a process for making a wheel assembly for a lightweight vehicle.

### BACKGROUND

A conventional non-inflatable wheel for baby strollers usually includes a wheel, a tire core made of an elastic foam material and disposed on the wheel, and a rubber casing wrapped on the tire core. However, since the elastic foam material of the tire core is liable to shrinkage at a relatively high temperature, compactness between the tire core and the rubber casing may be reduced, which may cause a dislocation between the tire core and the rubber casing, and thereby severely affecting a user's safety.

To solve the abovementioned problem, most of the existing techniques utilize the modification of structural designs of the tire core and/or the rubber casing, such as those disclosed in U.S. Patent Application Publication No. US2004/0007301 A1 and Chinese Utility Model Patent Publication No. CN 2631795Y, so as to provide a high compactness between the tire core and the rubber casing.

### SUMMARY

An object of the disclosure is to provide a process for making a wheel assembly for a lightweight vehicle so as to alleviate or eliminate the aforesaid shortcoming of the conventional wheel assembly for baby strollers.

According to the disclosure, a process for making a wheel assembly for a lightweight vehicle includes the steps of:

(a) providing a wheel which includes a rim having a recessed outer surface;

(b) disposing a foam tire core on the wheel such that an inner annular surface of the foam tire core is in abutment with the recessed outer surface of the rim;

(c) applying an adhesive agent on at least one of an inner surface of a rubber casing and an outer annular surface of the foam tire core; and

(d) wrapping the rubber casing on the foam tire core such that the inner surface of the rubber casing is brought into press engagement with the outer annular surface of the foam tire core.

The process for making a wheel assembly for a lightweight vehicle according to the disclosure can enhance the compactness between the foam tire core and the rubber casing through steps (c) and (d) as described above, so as to prevent dislocation between the foam tire core and the rubber casing.

### BRIEF DESCRIPTION OF THE DRAWINGS

Other features and advantages of the disclosure will become apparent in the following detailed description of the embodiment(s) with reference to the accompanying drawings, of which:

FIG. 1 is a flow diagram of an embodiment of a process for making a wheel assembly for a lightweight vehicle according to the disclosure;

FIG. 2 is an exploded perspective view of a wheel assembly made by the embodiment of the process according to the disclosure;

FIG. 3 is a perspective sectional view of a rubber casing of the wheel assembly;

FIG. 4 is a perspective view of the wheel assembly; and

FIG. 5 is a perspective sectional view of the wheel assembly.

### DETAILED DESCRIPTION

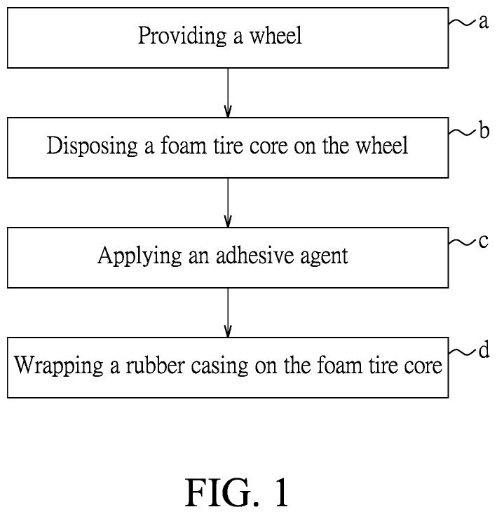

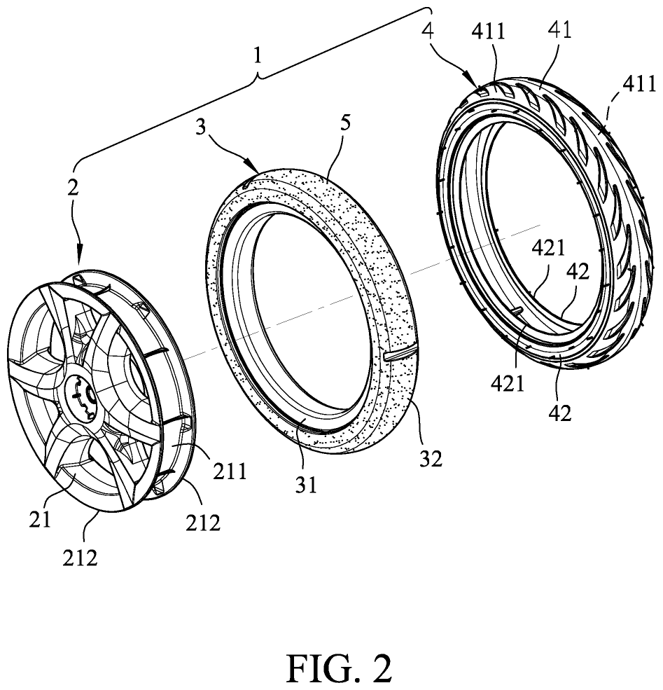

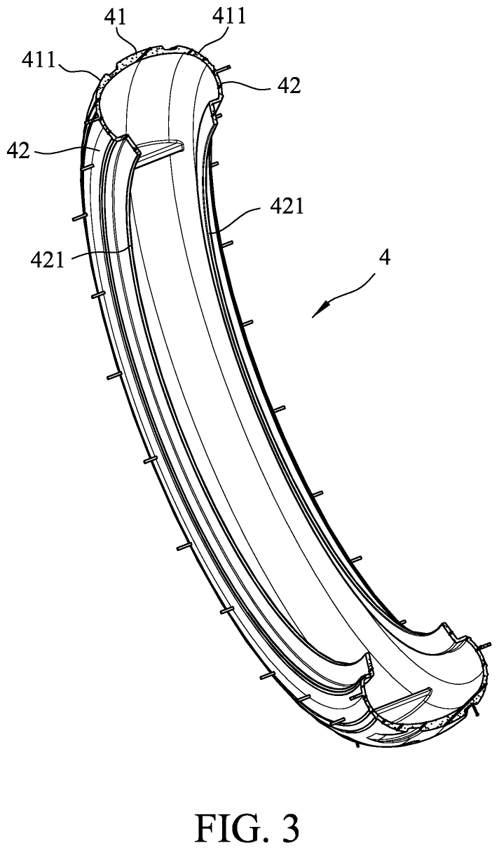

Referring to FIGS. 1, 2, and 3, an embodiment of a process for making a wheel assembly 1 for a lightweight vehicle includes the steps of: (a) providing a wheel 2, (b) disposing a foam tire core 3 on the wheel 2, (c) applying an adhesive agent 5, and (d) wrapping a rubber casing 4 on the foam tire core 3.

The wheel 2 includes a rim 21 having a recessed outer surface 211. The recessed outer surface 211 has two opposite edges 212.

The foam tire core 3 has an inner annular surface 31 and an outer annular surface 32 opposite to the inner annular surface 31, and is made of an elastic material. Examples of the elastic material suitable for making the foam tire core 3 include, but are not limited to, ethylene vinyl acetate, thermoplastic polyurethane, polypropylene and combinations thereof. The foam tire core 3 has a density ranging, for example, from 0.04×10³ kg/m³ to 0.12×10³ kg/ms, but is not limited thereto. In certain embodiments, the foam tire core 3 is made from polypropylene, and has a density ranging from 0.045×10³ kg/m³ to 0.09×10 kg/m³, thereby providing the foam tire core 3 with a better damping capacity. In certain embodiments, the foam tire core 3 is made from thermoplastic polyurethane, and has a density ranging from 0.04×10³ kg/m³ to 0.12×10³ kg/m³, thereby providing the foam tire core 3 with a better damping capacity.

The rubber casing 4 includes a rim wall 41 and two opposite circumferential side walls 42. The rim wall 41 has two opposite marginal regions 411. Each of the two opposite circumferential side walls 42 extends inwardly and radially from a corresponding one of the two opposite marginal regions 411 to terminate at a peripheral edge 421. The rubber casing 4 may be made of any rubber material commonly used for production of rubber casings.

The adhesive agent 5 may be any adhesive agents suitable for bonding rubber and elastic foam material. A non-limiting example of the adhesive agent 5 is 3M™ Scotch-Weld™ Industrial Adhesive 4799, which contains petroleum distillate, n-hexane, magnesium resinate (CAS #: 68037-42-3), talc, hydrocarbon resin, polyisoprene, poly(styrene-co-butadiene), zinc-calcium rosinate (CAS #: 68334-35-0), polystyrene, toluene and ethanol.

In step (b), the foam tire core 3 is disposed on the wheel 2 such that the inner annular surface 31 of the foam tire core 3 is in abutment with the recessed outer surface 211 of the rim 21.

In step (c), the adhesive agent 5 is applied on at least one of an inner surface of the rubber casing 4 and the outer annular surface 32 of the foam tire core 3.

In certain embodiments, the adhesive agent 5 is applied on the outer annular surface 32 of the foam tire core 3.

In certain embodiments, the adhesive agent 5 is applied on the inner surface of the rubber casing 4, and more particularly on at least one of an inner surface of the rim wall 41 and inner surfaces of the circumferential side walls 42. For example, the adhesive agent 5 may be applied on the inner surface of the rim wall 41 of the rubber casing 4, the inner surfaces of the two opposite circumferential side walls 42, or the inner surface of the rim wall 41 and the inner surfaces of the two opposite circumferential side walls 42. The adhesive agent 5 may be applied in a manner well-known in the art such as dispensing and spray coating, but is not limited thereto.

In step (d), the rubber casing 4 is wrapped on the foam tire core 3 such that the inner surface of the rubber casing 4 is brought into press engagement with the outer annular surface 32 of the foam tire core 3, and such that the peripheral edge 421 of each of the two opposite circumferential side walls 42 of the rubber casing 4 is brought to engagement with a corresponding one of the two opposite edges 212 of the recessed outer surface 211 of the rim 21. More particularly, the peripheral edge 421 of each of the two opposite circumferential side walls 42 of the rubber casing 4 is squeezed between the foam tire core 3 and a corresponding one of the two opposite edges 212 of the recessed outer surface 211 of the rim 21.

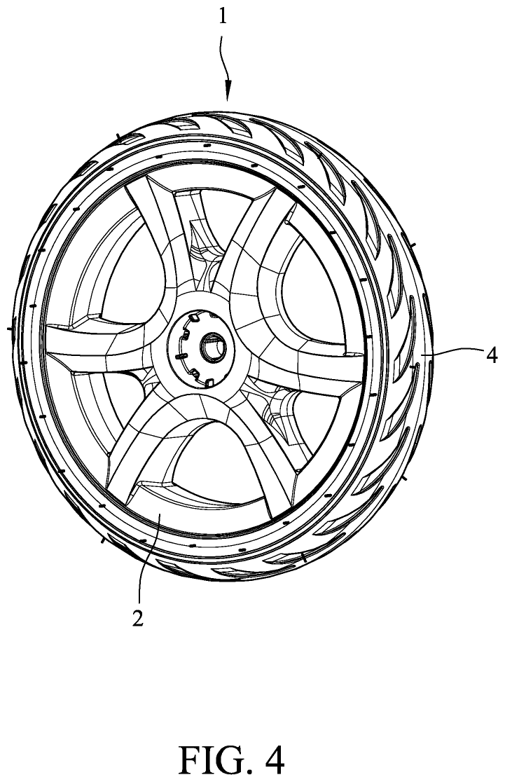

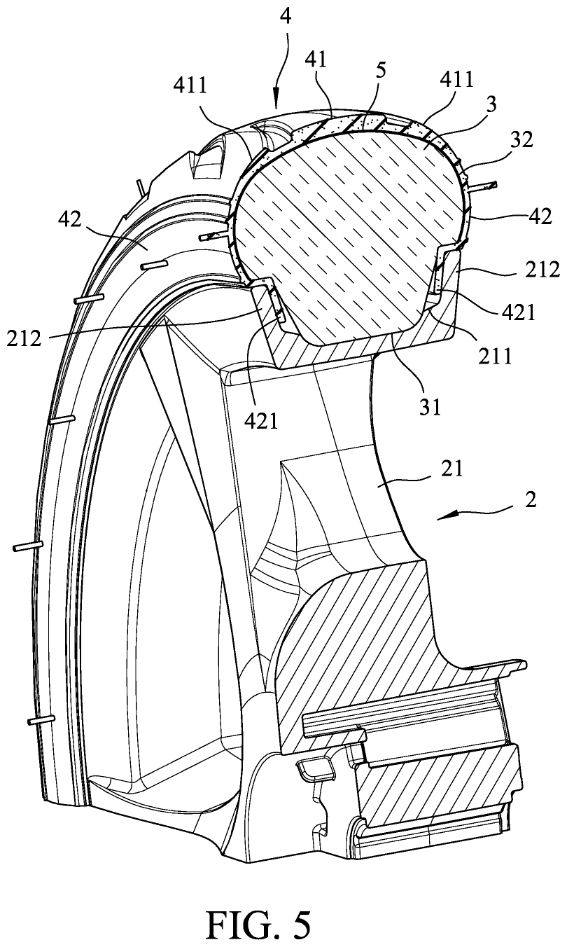

Referring to FIGS. 4 and 5, the wheel assembly 1 made by the embodiment of the process according to the disclosure includes the wheel 2, the foam tire core 3 disposed on the wheel 2, and the rubber casing 4 wrapped on the foam tire core 3 and adhered to the foam tire core 3 via the adhesive agent 5. Details of the wheel 2, the foam tire core 3, the rubber casing 4, and the adhesive agent 5 are omitted herein for the sake of brevity. The wheel assembly 1 is a non-inflatable tire, and can be used for baby strollers, bicycles, or the like.

Examples of the disclosure will be described hereinafter. It is to be understood that these examples are exemplary and explanatory and should not be construed as a limitation to the disclosure.

### Example 1

A wheel (size: 9.5 inches), a foam tire core (size: 11.5 inches, material: ethylene vinyl acetate, density: 0.141 g/cm³), and a rubber casing (size: 11.75 inches, material: rubber) were provided. The foam tire core was disposed on the wheel. An adhesive agent (3M™ Scotch-Weld™ Industrial Adhesive 4799, 0.9 g/pc) was applied on an outer annular surface of the foam tire core. The rubber casing was wrapped on the foam tire core such that an inner surface of the rubber casing was brought into press engagement with the outer annular surface of the foam tire core to obtain a wheel assembly (size: 11 inches) for a lightweight vehicle.

### Comparative Example 1

The procedures of Example 1 were repeated, except that the adhesive agent was not applied in Comparative Example 1.

### Property Evaluations:

### 1. Torsion Test

The torsion test was conducted for each of the wheel assemblies of Example 1 and Comparative Example 1 under tightened inspection according to the procedures as follows.

Each of the wheel assemblies of Example 1 and Comparative Example 1 was subjected to a thermal cycling for three times. Each thermal cycling was implemented by placing each of the wheel assemblies at an environment of 70° C. for 12 hours, followed by moving the wheel assemblies to another environment of 23° C. for 12 hours. Each of the wheel assemblies was then subjected to a torsion test using a torsion wrench (Manufacturer: KANON, Model: DTC-500EXL). The rubber casing of each of the wheel assemblies was rotated while holding the foam tire core at a fixed position, and the torsion formed between the rubber casing and the foam tire core when the rubber casing began rotating relative to the foam tire core was measured. The results of the torsion test are shown in Table 1 below.

### 2. Safety Test:

The safety test was conducted for each of the wheel assemblies of Example 1 and Comparative Example 1 under tightened inspection according to the procedures as follows.

Each of the wheel assemblies of Example 1 and Comparative Example 1 was subjected to a thermal cycling three times. Each thermal cycling was implemented by placing each of the wheel assemblies at an environment of 70° C. for 12 hours, followed by moving the wheel assemblies to another environment of 23° C. for 12 hours. Then, each of the wheel assemblies was installed on a baby stroller and subjected to a braking test according to the regulations of ASTM F833 and European EN1888 standards.

In addition, the safety test for each of the wheel assemblies of Example 1 and Comparative Example 1 was conducted under normal inspection. The normal inspection was different from the tightened inspection in that, the thermal cycling was not conducted on each of the wheel assemblies for the safety test under the normal inspection. The results of the safety test are shown in Table 1 below.

TABLE 1

| | | | Example | Comparative |
|---|---|---|---|---|
| | | | 1 | Example 1 |
| Torsion | Torsion | First | 413 | 9.9 |
| Test | between a | Trial | | |
| (tightened) | rubber casing | Second | 466 | 79.5 |
| | and a foam tire | Trial | | |
| | core (kgf) | | | |
| Safety Test | ASTM F833 | Normal | Not | Passed |
| | | inspection | Measured | |
| | | Tightened | Passed | Passed |
| | | inspection | | |
| | EN 1888 | Normal | Not | Passed |
| | | inspection | Measured | |
| | | Tightened | Passed | Failed |
| | | inspection | | (12 mm |
| | | | | displacement) |

Based on the results of the torsion test as shown in Table 1, the torsion between the rubber casing and the foam tire core of the wheel assembly of Example 1, which was recorded when the rubber casing began rotating relative to the foam tire core, is relatively high. The high torsion indicates a relatively high compactness between the rubber casing and the foam tire core of the wheel assembly of Example 1. In addition, based on the results of the safety test, the baby stroller installed with the wheel assembly of Example 1 passed the safety regulations according to the ASTM F833 and European EN1888 standards. In comparison, the wheel assembly of Comparative Example 1 not only exhibited a relatively low torsion between the rubber casing and the foam tire core thereof, but also failed to pass the safety regulation of the European EN1888 standard that is conducted under tightened inspection.

In order to pass the safety test conducted according to test methods 10.2.3, 10.2.4, or 10.2.5 of the European EN1888 standard, “a vehicle shall remain static on a slope for a minimum of 1 min,”, and the wheel assembly of Comparative Example 1 failed the braking test when a displacement of 12 mm was observed.

In sum, the process for making a wheel assembly for a lightweight vehicle according to the disclosure achieves an outstanding performance in enhancing the compactness between the foam tire core and the rubber casing through steps (c) and (d) of the process, thereby preventing a dislocation between the foam tire core and the rubber casing. In addition, the wheel assembly made by the process according to the disclosure exhibits a thermal stability that is comparable to a conventional inflatable tire and thus, a user of a lightweight vehicle (such as a baby stroller) installed with the wheel assembly can be assured with a high level of safety.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A process for making a wheel assembly for a lightweight vehicle, comprising the steps of:
(a) providing a wheel which includes a rim having a recessed outer surface;
(b) disposing a foam tire core on the wheel such that the an inner annular surface of the foam tire core is in abutment with the recessed outer surface of the rim;
(c) applying an adhesive agent on at least one of an inner surface of a rubber casing and an outer annular surface of the foam tire core; and
(d) wrapping the rubber casing on the foam tire core such that the inner surface of the rubber casing is brought into press engagement with the outer annular surface of the foam tire core.

2. The process according to claim 1, wherein in step (c), the adhesive agent is applied on the outer annular surface of the foam tire core.

3. The process according to claim 1, wherein the recessed outer surface of the rim has two opposite edges, and the rubber casing includes a rim wall having two opposite marginal regions and two opposite circumferential side walls, each of which extends inwardly and radially from a corresponding one of the two opposite marginal regions to terminate at a peripheral edge.

4. The process according to claim 14, wherein in step (c), the adhesive agent is applied on an inner surface of the rim wall.

5. The process according to claim 3, wherein in step (c), the adhesive agent is applied on inner surfaces of the two opposite circumferential side walls.

6. The process according to claim 3, wherein in step (c), the adhesive agent is applied on an inner surface of the rim wall and inner surfaces of the two opposite circumferential side walls.

7. The process according to claim 3, wherein in step (d), the peripheral edge of each of the two opposite circumferential side walls of the rubber casing is brought to engagement with a corresponding one of the two opposite edges of the recessed outer surface of the rim.

8. The process according to claim 3, wherein the peripheral edge of each of the two opposite circumferential side walls of the rubber casing is squeezed between the foam tire core and a corresponding one of the two opposite edges of the recessed outer surface of the rim.

9. The process according to claim 1, wherein the foam tire core is made of an elastic foam material.

10. The process according to claim 9, wherein the elastic foam material is selected from the group consisting of ethylene vinyl acetate, thermoplastic polyurethane, polypropylene and combinations thereof.
